(19) United States
(12) Patent Application Publication
(10) Pub. No.: US 2023/0307711 A1
(43) Pub. Date: Sep. 28, 2023

(54) Electrolyte and Its Preparation Method, Lithium-ion Battery

(71) Applicant: FULLYMAX BATTERY CO., LTD., Huizhou (CN)

(72) Inventors: Jianxiang DENG, Huizhou (CN); Changhao LIU, Huizhou (CN)

(73) Assignee: FULLYMAX BATTERY CO., LTD., Huizhou (CN)

(21) Appl. No.: 18/314,831

(22) Filed: May 10, 2023

Related U.S. Application Data
(63) Continuation of application No. PCT/CN2021/109785, filed on Jul. 30, 2021.

(30) Foreign Application Priority Data
Jun. 29, 2021 (CN) 202110752073.6

(51) Int. Cl. H01M 10/0569; H01M 10/0525

(52) U.S. Cl. CPC H01M 10/0569; H01M 10/0525; H01M 2300/004

(57) ABSTRACT

An electrolyte includes following components of quantity shares: lithium salt 12-18 shares, linear carbonic ester 20-35 shares, cyclic carbonic ester 20-35 shares, carboxylic ester 20-50 shares and functional additive 10-15 shares.

### TECHNICAL FIELD

This invention involves in one kind of electrolyte and its preparation method, lithium-ion battery.

### BACKGROUND TECHNOLOGY

With the increasing needs of portable devices, there are also higher and higher requirements for energy density of lithium-ion battery. The energy density of power lithium-ion battery is usually low, it can be quickly improved by increasing charge voltage, for example, improving charge voltage to 4.45 V from 4.2 V, and energy density will increase by 30%, but when charge voltage is increased to 4.45 V, lithium-ion battery will be in high electrodynamic force at 4.45 V cathode material is easy to dissolve out Co2+ and worsen anode, meanwhile electrolyte will encounter oxygenolysis easily, it will have reduzates at anode and worsen anode, which will seriously affect cycle performance of battery.

In addition, high rate lithium-ion battery has good performance, such as high conductivity, high lithium salt, low quantity of organic solvent modules, low impedance of additives. It's easy for such electrolytes to dissolve at high voltage of 4.45 V, the capacity of film forming strength on cathode and anode surface is weak, storage performance at high temperature is bad and high rate charge and discharge cycle performance is bad. Therefore, storage performance at high temperature and high rate charge and discharge cycle performance is relatively bad for lithium-ion of lithium cobalt oxides at 4.45 V.

### SUMMARY

It is necessary to provide electrolyte and its preparation method and lithium-ion battery with better storage performance at high temperature and charge and discharge cycle performance at high voltage and high rate.

One kind of electrolyte, including following quantity groups:

Lithium salt 12-18 shares;

Linear carbonic ester 20-35 shares;

Cyclic carbonic ester 20-35 shares;

Carboxylic ester 20-50 shares;

Functional additives 10-15 shares.

One preparation method for electrolyte, including following steps:

Mix linear carbonic ester with cyclic carbonic ester and carboxylic ester, then mixed organic solvent is obtained;

Add lithium salt to above mentioned mixed organic solvent and mix them for first time; premixing electrolyte is obtained;

Add functional additives to above mentioned premixing electrolyte on basis of weight ratio and mix all for second time, described electrolyte is obtained.

One kind of lithium-ion battery, described lithium-ion battery includes electrolytes in any Embodiments above.

Details for one or more Embodiments of this invention are put forward in attached figures and descriptions below. Other characteristics, purposes and advantages of this invention can be apparently observed from instructions, attached figures and claims.

### INSTRUCTIONS FOR ATTACHED FIGURE

It is to clearly explain Embodiments of this invention or technical solutions in current technologies. A brief introduction to attached figures that are needed in Embodiments or technical description will be made as below. Apparently, attached figures are only parts of Embodiments. For ordinary technicians in the field, they can acquire attached figures for other Embodiments based on these figures without making creative efforts.

FIG. 1 is flow chart of electrolyte preparation method in an embodiment;

FIG. 2 is rate discharge curve of lithium-ion battery using electrolyte shown in FIG. 1;

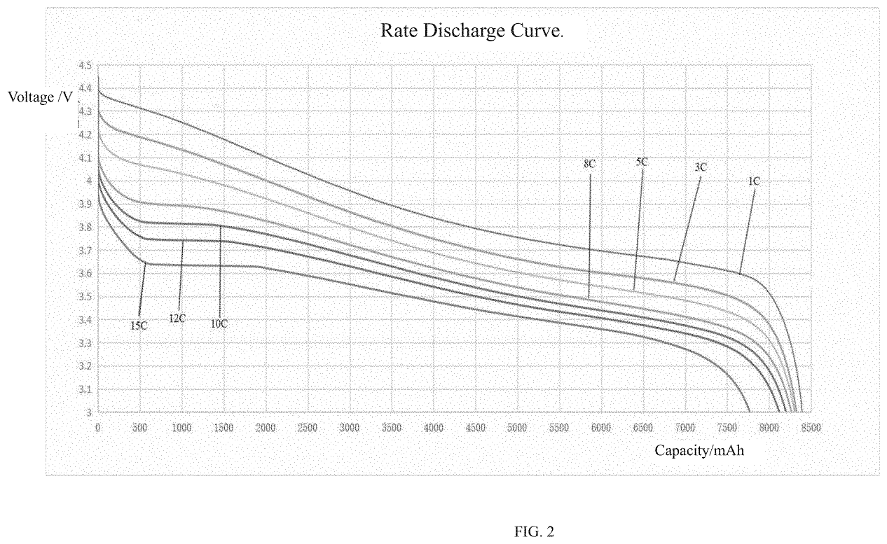

FIG. 3 is diagram of charge and discharge cycle life change of lithium-ion battery using electrolyte shown in FIG. 1.

### DETAILED DESCRIPTION

In order to understand this invention easily, full description is made for this invention in accordance with related attached figures as references. The attached figure provides best implementation way of this invention. However, the invention can be achieved by many different forms, it's not limited to the implementation way described in this file. On the contrary, the purpose of providing these implementation ways is to promote deep and full understanding of public contents of the invention.

It is necessary to point out that when a part is called “fastened to ” another part, it can be tight on top of another part or there may be centered part When a part is believed to be “connected” to another part, it can be directly connected to another part or there may be centered part at the same time. The words “vertical” “horizontal” “left” “right” and similar expressions used in the file are only for explanation, and it doesn't mean it's the only implementation method.

Unless there is another definition, all technologies and scientific terms used in this file have the same meanings as understanding meaning of technicians working in this field related to the invention. Terms used in this file of the instruction are only for purpose of describing concrete implementation, they are not for limiting the invention. Terminologies used in this file “and/or” include random and all combination of one or more related listed projects.

The application provides one kind of electrolyte. The electrolyte above includes following quantity groups: lithium salt 12-18 shares, linear carbonic ester 20-35 shares, cyclic carbonic ester 20-35 shares, carboxylic ester 20-50 shares and functional additives 10-15 shares.

The electrolyte above includes organic solvent coming from mixed linear carbonic ester, cyclic carbonic ester and carboxylic ester. Among them, cyclic carbonic ester has high impedance and it can improve stability of electrolytes, which can make lithium-ion battery won't dissolve out cobalt-ion at 4.45 V electrodynamic force and keep good stability, which will improve storage performance of lithium-ion battery at high temperature and charge and discharge cycle performance. However, the impedance of electrolyte is relatively high, it will make it difficult for lithium-ion battery to output high power and it's difficult to achieve the effect of high rate. The invention can assure high voltage and good stability of electrolyte by mixing linear carbonic ester and cyclic carbonic ester with certain ratio, and it can effectively improve rate of lithium-ion battery and high rate charge and discharge cycle performance and increase energy density of lithium-ion battery effectively. The dielectric constant of cyclic carbonic ester is high, dissociation constant is good, which means cyclic carbonic ester makes organic solvent have good capacity to dissolve lithium salt, which will make electrolyte have better conductivity and strengthen electrolyte conductivity. Furthermore, dissolve and mix lithium salt, linear carbonic ester, cyclic carbonic ester and carboxylic ester on the basis of certain ratio, which will further improve conductivity of electrolyte solution system and high rate charge and discharge cycle performance. In addition, high voltage high rate charge and discharge cycle performance of electrolyte can be improved by functional additives.

In an embodiment, lithium salt is at least one kind of the following items, namely lithium bis(trifluoromethanesulphonyl)imide, lithium di(fluorosulfonyl)imide and lithium hexafluorophosphate. In this embodiment, lithium bis(trifluoromethanesulphonyl)imide has good stability at high temperature and in chemistry. The decomposition point of lithium bis(trifluoromethanesulphonyl)imide can reach 370° C. and the adding of electrolyte of high voltage and high rate to lithium bis(trifluoromethanesulphonyl)imide can effectively reduce the risk of electrolyte decomposition at high temperature. In the system of secondary lithium-ion battery, lithium bis(trifluoromethanesulphonyl)imide can play an important role in LFP and NMC systems, it can work with LiFP6 as additive to use, it can also be used as main electrolyte independently. Lithium di(fluorosulfonyl)imide can effectively reduce high and low temperature resistance for SEI layer formed on surface of plate electrode at low temperature and reduce capacity loss during placement, it can improve battery capacity and electrochemistry performance and can be used as electrolyte for one time battery. Lithium di(fluorosulfonyl)imide has also high stability and it has some advantages, such as no decomposition at temperature below 200° C., good stability of hydrolysis and environment friendliness. Lithium hexafluorophosphate forms SEI film on electrodes, especially on carbonaceous anode and passivatiion can be achieved on current collector of cathode and prevent it from dissolving. At the same time, lithium hexafluorophosphate has wide electrochemical stability window which is beneficial to output of high power for lithium-ion battery and then it can achieve high voltage and high rate. In addition, the mixed solvent of lithium hexafluorophosphate with linear carbonic ester, cyclic carbonic ester and carboxylic ester has good dissolving capacity which can effectively improve conductivity of electrolyte.

In an embodiment, linear carbonic ester is one of the following items, diethyl carbonate, ethyl methyl carbonate and dimethyl carbonate. It is understandable that electrolyte of lithium battery is the carrier of ion transportation in battery, organic solvent is main part of electrolyte and it's closely related to electrolyte performance. If the impedance is high and conductivity is bad after organic solvent dissolves with lithium salt, then high voltage and high rate effect won't be achieved. In the embodiment, linear carbonic ester is one of following items, diethyl carbonate, ethyl methyl carbonate and dimethyl carbonate. Diethyl carbonate, ethyl methyl carbonate and dimethyl carbonate have low viscosity and low impedance, which can effectively improve transmitting speed of lithium-ion in electrolyte. In addition, ethyl methyl carbonate has active reaction genes including methyl, ethyl and carbonyl. As a fine combined medium, it can react with alcohol, phenol, amine and ester. As cosolvent of non-water solution dielectric medium, ethyl methyl carbonate can improve lithium-ion battery performances, such as the increase of energy density, discharge capacity, use stability and safety.

In an embodiment, cyclic carbonic ester is one of the following items, ethylene carbonate and propylene carbonate. It is understandable that electrolyte of lithium battery is the carrier of ion transportation in battery, organic solvent is main part of electrolyte and it's closely related to electrolyte performance. If the impedance is high and conductivity is bad after organic solvent dissolves with lithium salt, then high voltage and high rate effect won't be achieved. In order to improve stability and conductivity of electrolyte of lithium-ion, cyclic carbonic ester is one of the following items, ethylene carbonate and propylene carbonate in the embodiment. Ethylene carbonate has high dielectric constant, it can not only promote dissociation of various lithium salts like LiFP6, its reduzates will be helpful to form a sound solid electrolyte interface (SEI film) to improve stability of electrode interface. In addition, electrolyte including EC can effectively restrain the stripping of graphite anode and extend cycle life. Lithium-ion can form stable Li⁺-EC structure together with ethylene carbonate (EC) to improve electrolyte stability. It is necessary to point out that battery performance will quickly decline when there is SEI film on electrode surface and electrolyte is ethyl methyl carbonate or diethyl carbonate, and it will come along with big voltage polarization, and SEI film can't effectively restrain decomposition of electrolyte during process of charge and discharge. But the decomposition of electrolyte during process of charge and discharge can be restrained after ethylene carbonate is added and mixed solution can be formed, polarization will be eased and cycle stability is also improved apparently. Although the dielectric constant of ethylene carbonate and propylene carbonate is high and capacity in dissolving lithium salt is sound, when lithium salt is dissolved to a certain concentration, it will increase viscosity of solvent, which will make it difficult to continue dissolving of lithium salt and better conductivity can't be achieved. In the embodiment, adding diethyl carbonate, ethyl methyl carbonate and dimethyl carbonate to solvent of ethylene carbonate and propylene carbonate can effectively reduce viscosity of solvent and transmitting speed of lithium-ion and conductivity of electrolyte can be improved, which will achieve high voltage and high rate effect for lithium battery.

In an embodiment, carboxylic ester is at least one of the two items, propyl propionate and ethyl propionate It can be understood that solvent is main component of electrolyte, it accounts for 70% of total electrolyte quantity and its nature is closely related to electrolyte performance. The viscosity, fusion point, boiling point, conductivity and flash point of solvent have important impact on the use temperature of battery, solubility of lithium salt, electrochemical performance of electrodes and battery performance. In order to improve performance of electrolyte and achieve effect of high voltage and high rate for lithium-ion battery, carboxylic ester is at least one of the following items, propyl propionate and ethyl propionate. Compared with linear carbonic ester, propyl propionate and ethyl propionate have lower freezing point and viscosity and the average freezing point of propyl propionate and ethyl propionate is 20˜30° C. lower than that of carbonic ester and they have better performance at low temperature. In other words, propyl propionate and ethyl propionate can further improve conductivity of electrolyte and improve discharge performance of electrolyte at low temperature. In addition, the mixing of propyl propionate and ethyl propionate at certain ratio can have less surface tension for electrolyte, which will further improve conductivity of electrolyte, especially the mixing and reaction with cyclic carbonic ester, conductivity of electrolyte can be improved and stability and safety of electrolyte can be assured.

In an embodiment, functional additive is one of following items including lithium salt additive, nitrile additive, sulfur additive, fluorine additive, vinylene carbonate and 1-propanephosphonic anhydride solution. Lithium salt additive can further promote the formation of inorganic SEI film in this embodiment and achieve effective passivation for electrode current collector to prevent it from dissolving and improve the stability of electrolyte. Nitrile additive can form film on cathode before solvent, which will fulfil effect of oxidation resistance and improve stability of cathode materials and it will also be beneficial to achieving effect of high voltage and high rate of lithium-ion battery. Sulfur additive can form film on anode before solvent, which will achieve effect of oxidation resistance and improve stability of anode materials and it will also be beneficial to achieving effect of high voltage and high rate of lithium-ion battery. Fluorine additive is fluoro compound containing fluorine, for example, ethylene carbonate will form fluoro ethylene carbonate through fluoro reaction, the substance structure of fluoro ethylene carbonate is more stable and it's not easy to have oxidization and reduction, which is beneficial to long cycle for electrolyte and high rate charge and discharge cycle performance of lithium-ion battery can be improved. Vinylene carbonate involves in the formation of SEI in process of first charge, and the main component of formed interface is reducing polymer of lithium carbonate and vinylene carbonate. The SEI formed on graphite electrode surface by electrolyte containing vinylene carbonate additive is fuller and film cover rate between particles. In addition, compared with first capacity cycle, charge and discharge of lithium-ion battery have big improvement. In other words, SEI formed by electrolyte containing vinylene carbonate additive can effectively improve specific capacity and cycle stability of high voltage and high rate lithium-ion battery. 1-propanephosphonic solution is good coupling agent and dehydrating agent and meanwhile 1-propanephosphonic solution can transform amide to nitrile compound and the effect of film formed on cathode can be improved, which will enhance effect of oxidation resistance, improve stability of cathode materials and strengthen effect of high voltage and high rate of lithium-ion battery.

In an embodiment, lithium salt additive is at least one of the following items including lithium difluoro(oxalato)borate, lithium bis(oxalate) borate and lithium bis(trifluoromethanesulphonyl)imide. It can be understood that good SEI has insolubility in organic solvent and allows lithium ions to freely move in and out and solvent molecule can't penetrate, which can stop solvent molecule co-interpolation from damaging electrodes and improve cycle efficiency and reversible capacity performance of lithium-ion battery. In order to promote SEI film formation speed and performance, lithium salt additive is at least one of the following items including lithium difluoro(oxalato)borate, lithium bis(oxalate) borate and lithium bis(trifluoromethanesulphonyl)imide. Lithium difluoro(oxalato)borate additive is used as additive for high voltage film formation of lithium-ion electrolyte. As such kind of additive has low oxidation potential and high reduction potential, it can form a layer of compact and stable SEI film on cathode and anode surface during process of first charge and discharge, it can optimize cathode and anode surface film, reduce resistance between cathode and electrolyte, restrain surface activeness of electrodes to limit contact between electrolyte and active substance of electrodes, reduce oxygenolysis of main solvent of electrolyte on electrode surface, prevent cathode materials of high voltage and high rate lithium-ion battery from dissolving out Co²⁺ with excessive quantity which will lead to the collapse of structure, which will improve stability of cathode materials and it's beneficial to achieving effect of high voltage and high rate of lithium-ion battery. The conductivity of lithium bis(oxalate) borate is high and it's good for film formation on graphite anode. Lithium bis(oxalate) borate has good performance at high temperature. It can improve storage performance of electrolyte at high temperature when protecting graphite anode, especially when electrolyte is at high voltage, for example, it's easier to decompose at high voltage of 4.45 V. Furthermore, solubility of lithium bis(oxalate) borate is low, partial solvents of low dielectric constant is hardly dissolved and it has bad compatibility with partial cathode, which will be beneficial to formation of SEI film on anode and have no impact on cathode materials and stability of high voltage and high rate electrolyte. Lithium bis(trifluoromethanesulphonyl)imide is important organic ion compound containing fluorine and it can be as electrolyte additive to promote formation of SEI film. Compared with traditional LiFP6, lithium bis(trifluoromethanesulphonyl)imide has high electrochemical stability and conductivity and it doesn't have corrosive action against aluminum liquid collector at relatively high voltage, it won't react with water and can depress gas production and it won't have gas swell on battery, which is beneficial to output of high rate of lithium-ion battery and it can improve stability of electrolyte at high voltage and high rate and cycle performance of high voltage and high rate lithium-ion battery can be enhanced.

In an embodiment, nitrile additive is at least one of the following items including adiponitrile, succinonitrile and 1,3,6-Hexanetricarbonitrile. It can be understood that when lithium-ion battery has high voltage, if charge voltage is increased to 4.45 V, lithium-ion battery will be at high electrodynamic force, it's easy for cathode materials to dissolve out Co²⁺ and worsen anode, meanwhile electrolyte groups will be oxidized and decomposed easily, reduzates will happen at anode and worsen anode, which will seriously affect cycle performance of battery and easily affect high temperature performance of electrolyte at high voltage. Fluoroethylene carbonate in embodiment above is helpful to improve work voltage, but it will have impact on high temperature performance of lithium-ion battery. In order to protect cathode materials and improve stability and cycle performance of lithium-ion battery. In the embodiment, nitrile additive is at least one of the following items including adiponitrile, succinonitrile and 1,3,6-Hexanetricarbonitrile. Adiponitrile electrolyte won't form film on anode surface and it will form a complicated structure together with nitrile bond and transition metal ion on cathode surface, depress dissolution of metal ions and sedimentation at anode, which can improve high temperature performance of lithium cobalt oxides at high voltage. Furthermore, quantity share of adiponitrile in the embodiment is 0.3-0.7 shares, and the same quantity of electrolyte as adiponitrile above is used, high temperature of lithium cobalt oxides at high voltage can be improved effectively and cycle performance won't be affected. But if addition quantity is excessive, it won't be helpful to improve cycle performance and high temperature performance of lithium-ion battery. Succinonitrile has CN functional group, it can react with acid and water and reduce content of free acid and water in electrolyte, then electrolyte stability can be improved. Succinonitrile can expand electrochemical stability window of electrolyte in the embodiment, it can improve oxygenolysis voltage of electrolyte so that work voltage of electrolyte can be increased, reduce electrolyte decomposition on active points of cathode materials so that impedance value of material surface can be decreased and improve discharge capacity of cathode material, initial efficiency and cycle performance. In addition, the purity of succinonitrile can reach over 99.95% and quantity shares of succinonitrile is 2-4 shares, which will further improve initial efficiency and specific discharge capacity of electrolyte. If succinonitrile is used with excessive quantity, it will be easy to increase viscosity of electrolyte, rate performance will decline and specific capacity and cycle performance of cathode materials will be affected. 1,3,6-Hexanetricarbonitrile has high polarity of succinonitrile and aliphatic hydrocarbon performance of adiponitrile, it has good compatibility with solvent, and nitrile additive can react with micro water in electrolyte with existence of micro acid and produce new compound amide so that function of micro acid and water in electrolyte can be eliminated, the reaction between LiFP6 and micro acid as well as water can be depressed, which will improve performance of high voltage high rate lithium-ion battery.

In an embodiment, sulfur additive is at least one of the following items including propylene sulfite, ethylene sulfite and 1,3-propylene sultone. It can be understood that sulfur additive can form film on anode prior to solvent in electrolyte to achieve effect of reduction resistance, improve stability of anode materials, and it's beneficial to achieve affect of high voltage and high rate of lithium-ion battery. In order to improve the effect of film formation on anode of lithium-ion battery, sulfur additive is at least one of the following items including propylene sulfite, ethylene sulfite and 1,3-propylene sultone in the embodiment. Propylene sulfite is liquid at room temperature and it's not sensitive to light and heat. Adding propylene sulfite to high voltage and high rate electrolyte can make it easy to store high voltage and high rate electrolyte and improve storage performance of electrolyte at high temperature. Propylene sulfite added to high voltage and high rate electrolyte will form SEI film after reduction on graphite electrode surface prior to solvent and depress reduction of electrolyte solvent on graphite electrode. Adding propylene sulfite to electrolyte can improve charge and discharge cycle performance of lithium-ion battery. Ethylene sulfite joins process of SEI formation through reducing decomposition, which can partially depress decomposition of solvent. Meanwhile, ethylene sulfite is prior to electrolyte solvent in reducing decomposition, which changes the components of SET film and the shape of SEI film on electrode surface can be improved after ethylene sulfite is added to electrolyte, film formed on anode electrode surface will be smooth and even, which will improve stability of anode of lithium-ion and make lithium-ion battery reach high voltage and high rate status, it has good stability, charge and discharge cycle performance and high specific capacity. Besides, a layer of thin and stable SEI film will be formed on electrode surface after ethylene sulfite is added, which can decrease resistance during lithium ion migration in electrode process, this is beneficial to process of reversible embedding and taking off of lithium and work stability of lithium-ion battery at high voltage and high rate can be enhanced. It can be understood that increasing work voltage is one of important ways to improve energy density of lithium-ion battery. But at high voltage, metal ions in cathode materials can be dissolved easily in electrolyte, and electrolyte will be easily oxygenized and decomposed on surface of cathode, metal ions dissolved in electrolyte will easily sediment on anode and SET film will be damaged because concentration is increased. This situation will be intensified when it's at high temperature. In order to reduce metal ions in cathode, such as dissolving of cobalt ions and sedimentation on anode, sulfur additive is 1,3-propylene sultone in the embodiment. 1,3-propylene sultone (PST) and Methylene Methanedisulfonate (MMADS) belong to sulphonate category which is more stable than MMDS and it can form stable SEI film. 1,3-propylene sultone (PST) will be reduced and decomposed on graphite surface prior to solvent molecule and form stable SEI film and depress co-embedding of PC solvent. In addition, SET film formed by 1,3-propylene sultone has higher stability and it can depress reducing decomposition of solvent molecule on anode and it won't be damaged at high temperature, which can effectively improve storage performance at high temperature and charge and discharge cycle performance of high voltage and high rate lithium-ion battery. In other words, 1,3-propylene sultone can form stable SEI film on surface of cathode and anode and depress co-embedding and reducing decomposition of solvent molecule on anode, which will improve cycle performance and high temperature performance of high voltage LCO (lithium cobalt oxides) lithium-ion battery. However, impedance of SEI film formed by 1,3-propylene sultone will increase apparently, which will worsen low temperature performance of HV lithium-ion battery. Furthermore, mixing and reacting 1,3-propylene sultone with propylene sulfite and ethylene sulfite can change shape of SEI film in the embodiment and make SEI film thinner and more stable, which will reduce impedance of SEI film at low temperature and achieve stable high voltage and high rate for lithium-ion battery at low temperature.

In an embodiment, fluorine additive is at least one of following items including fluoroethylene carbonate and lithium difluorophosphate. It can be understood that there are seven electrons at external layer of electron orbit of fluorine, the electronegativity is strong and there is weak polarity. Fluorination of solvent can reduce freezing point, flash point is increased and oxidation resistance is improved, which is helpful to improve contact performance between electrolyte and electrodes. The use of fluoro solvent or additive in electrolyte can improve low temperature performance, oxidization resistance performance, flame resistance performance and wettability of electrodes, which will be helpful to obtain fluorine containing high voltage electrolyte, fluorine containing flame resistance electrolyte and fluorine containing wide temperature window electrolyte and other fluorine containing electrolytes. In the embodiment, fluorine additive is at least one of following items including fluoroethylene carbonate and lithium difluorophosphate. The SEI film on electrode surface is mainly decomposition product of fluoroethylene carbonate, as fluoroethylene carbonate is at high potential and its decomposition substance is covered on electrode surface and SEI film with good performance will be formed, which can effectively depress decomposition of electrolyte solvent at lower potential. It is necessary to clarify that fluoroethylene carbonate has one more fluoro-substitution group than ethylene carbonate from the view of structure, fluoro-substitution group has good capacity in electron absorption, thus it can be explained that fluoroethylene carbonate can have reducing decomposition reaction at relatively high potential. Fluoro-substitution group can make electrolyte more stable during charge and discharge process and it's beneficial to long cycle of high voltage and high rate lithium-ion electrolyte. In the embodiment, adding 1-3 shares of fluoroethylene carbonate to electrolyte can improve specific capacity and cycle performance of high voltage and high rate lithium-ion battery. SET film formed by decomposed substance of fluoroethylene carbonate is thin and stable, which is beneficial to embedding and taking off for lithium ions, reducing impedance of SEI film on electrodes and total impedance of lithium-ion battery. Lithium difluorophosphate can form dielectric medium interface film with stability and good ion transportation performance on surface of cathode and anode, stabilize electrode/electrolyte interface, depress decomposition of electrolyte and reduce interface impedance of battery, which can apparently improve cycle stability and rate performance at high temperature and low temperature respectively. Lithium difluorophosphate is beneficial to reducing polarity of electrodes, which can improve cycle stability of electrodes and electrolyte.

The application provides another preparation method for electrolyte, including following steps: it's to mix linear carbonic ester, cyclic carbonic ester and carboxylic ester, mixed organic solvent is obtained; Add lithium salt to mixed organic solvent and mix them for first time, premixing electrolyte is obtained; Add functional additives to above-mentioned premixing electrolyte on basis of weight ratio and mix them for second time, then required electrolyte is obtained.

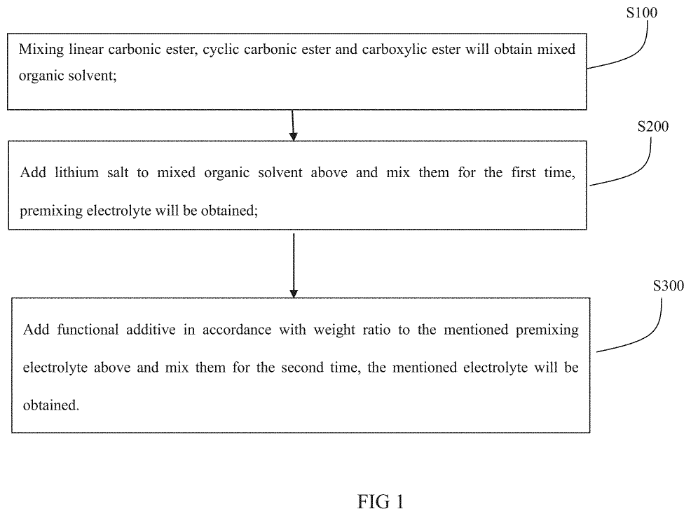

In order to have a better understanding of preparation method of the electrolyte of the invention, there are further explanations as below for preparation method of the electrolyte of the invention, as it's shown in FIG. 1, preparation method with one implementation way for electrolyte can be used for making electrolyte for any cases above. Furthermore, preparation method includes following partial steps or all:

S100. Mix linear carbonic ester with cyclic carbonic ester and carboxylic ester, mixed organic solvent is obtained.

In the embodiment, measure weight of linear carbonic ester, cyclic carbonic ester and carboxylic ester respectively based on mass ratio and mix them fully for dissolving and reaction of lithium salt and functional additives later. Among them, cyclic carbonic ester and carboxylic ester have high impedance, which can improve stability of electrolyte and make lithium-ion won't dissolve out cobalt ions and have good stability with 4.45 V electrodynamic force, and storage performance at high temperature and charge and discharge cycle performance of lithium-ion battery can be improved. But impedance of electrolyte is big, thus it's relatively difficult to output high power for lithium-ion battery, which means it's difficult to achieve high rate. The invention can make electrolyte improve rate of lithium-ion battery and charge and discharge cycle performance at high rate while maintaining high voltage and good stability by mixing linear carbonic ester with a certain ratio with carbonic ester and cyclic carbonic ester and increase energy density of lithium-ion battery effectively. The mass ratio of linear carbonic ester and cyclic carbonic ester is 1/1˜4/7, and mass ratio of cyclic carbonic ester and carboxylic ester is 1/1˜2/5.

S200, Add lithium salt to mixed organic solvent and mix for first time, premixing mixed electrolyte is obtained;

In the embodiment, add measured lithium salt to mixed organic solvent, and mix for first time, make sure lithium salt is fully dissolved in organic solvent, dissolve and mix lithium salt, linear carbonic ester, cyclic carbonic ester and carboxylic ester with certain ratio to improve conductivity capacity of solvent system of electrolyte, which will improve high rate charge and discharge cycle performance of lithium-ion battery. Additionally, it can mix and disperse additives better later. The concentration of lithium salt is 1.0 mol/L˜1.8 mol/L.

S300, Add functional additive to premixing electrolyte with weight ratio, and mix them for second time, electrolyte is obtained.

In the embodiment, add measured functional additive to premixing electrolyte in order in accordance with weight ratio, and mix them for second time and make functional additive fully mixed and reacted with premixing electrolyte, which will further improve charge and discharge cycle performance at high voltage and high rate of electrolyte. Among them, the adding quantity of additives is 2% wt-5% wt.

In an embodiment, mass ratio of linear carbonic ester, cyclic carbonic ester and carboxylic ester is 2:3:2. It can be understood that the impedance of cyclic carbonic ester and carboxylic ester is big and it can improve stability of electrolyte and make it difficult for lithium ions to dissolve out cobalt ions at 4.45 V with high electrodynamic force and stability is sound, which can enhance storage performance at high temperature and charge and discharge cycle performance. But the impedance of electrolyte is big, thus it's relatively difficult to output high power for lithium-ion battery, which means it's difficult to achieve high rate. Mass ratio of linear carbonic ester, cyclic carbonic ester and carboxylic ester is 2:3:2 in the embodiment to have good stability and low impedance for electrolyte, electrolyte can support output of high voltage and high rate of lithium-ion battery while maintaining high voltage and good stability by mixing linear carbonic ester at certain ratio with carbonic ester and cyclic carbonic ester, it can effectively improve rate of lithium-ion battery and charge and discharge cycle performance at high rate and increase energy density of lithium-ion battery.

The application also provides one kind of lithium-ion battery, the above mentioned high voltage and high rate lithium-ion battery includes electrolytes described in any embodiments above.

Compared with current technology, the invention has at least following advantages:
1. The invention includes organic solvent mixed by linear carbonic ester, cyclic carbonic ester and carboxylic ester. Among them, the impedance of cyclic carbonic ester and carboxylic ester is big, which can improve stability of electrolyte and make lithium-ion battery won't dissolve out cobalt ions at 4.45 V with high electrodynamic force and have good stability, storage performance at high temperature and charge and discharge cycle performance of lithium-ion battery can be increased. But the impedance of electrolyte is big, thus it's relatively difficult to output high power for lithium-ion battery, which means it's difficult to achieve high rate. In the invention, linear carbonic ester is mixed at certain ratio with carbonic ester and cyclic carbonic ester, electrolyte can effectively improve rate of lithium-ion battery and charge and discharge cycle performance at high rate and increase energy density of lithium-ion battery while maintaining high voltage and good stability.
2.The dielectric constant of cyclic carbonic ester in the invented electrolyte is big, and dissociation constant is good, which means that cyclic carbonic ester makes organic solvent have better capacity in dissolving lithium salt so that conductivity of electrolyte can be improved and strengthened. Moreover, mixing lithium salt, linear carbonic ester, cyclic carbonic ester and carboxylic ester at certain ratio will further improve conductivity of electrolyte solvent system, which will enhance high rate charge and discharge cycle performance of lithium-ion battery. In addition, functional additive can also boost high voltage and high rate charge and discharge cycle performance of electrolyte.

As some embodiments shown below, if % is mentioned, it means it's calculated by weight percentage. It shall be noted that following embodiments haven't listed out all possible situations and all materials used in following embodiments can be obtained by commercial channels if there is no special statement.

### Embodiment 1

In a glove box which is full of argon, mix weighed electrolyte solvent linear carbonic ester, cyclic carbonic ester and carboxylic ester, mixed organic solvent is obtained and mass ratio of linear carbonic ester, cyclic carbonic ester and carboxylic ester is 1:1:1. Then add weighed lithium salt to mixed organic solvent and mix them for the first time and make lithium salt dissolve in mixed organic solvent and concentration of lithium salt is 1.0 mol/L. Then add weighed functional additive at certain ratio to premixing electrolyte in order and mix for the second time, and the adding quantity of functional additive is 2% wt.

### Embodiment 2

In a glove box which is full of argon, mix weighed electrolyte solvent linear carbonic ester, cyclic carbonic ester and carboxylic ester, mixed organic solvent is Obtained and mass ratio of linear carbonic ester, cyclic carbonic ester and carboxylic ester is 2:3:2. Then add weighed lithium salt to mixed organic solvent and mix them for the first time and make lithium salt dissolve in mixed organic solvent and concentration of lithium salt is 1.4 mol/L. Then add weighed functional additive at certain ratio to premixing electrolyte in order and mix for the second time, and the adding quantity of functional additive is 3% wt.

### Embodiment 3

In a glove box which is full of argon, mix weighed electrolyte solvent linear carbonic ester, cyclic carbonic ester and carboxylic ester, mixed organic solvent is obtained and mass ratio of linear carbonic ester, cyclic carbonic ester and carboxylic ester is 2:2:3. Then add weighed lithium salt to mixed organic solvent and mix them for the first time and make lithium salt dissolve in mixed organic solvent and concentration of lithium salt is 1.8 mol/L. Then add weighed functional additive at certain ratio to premixing electrolyte in order and mix for the second time, and the adding quantity of functional additive is 5% wt.

### Verification of Embodiments

The implementation case is based on a 8,000 mAH lithium-ion battery with high rate and high voltage. The cathode uses 4.45 V lithium cobalt oxides, anode uses man-made graphite, separator is PE ceramic separator, electrolyte formula is: the mixing of electrolyte solvent, electrolyte additives and LiFP6, among them electrolyte solvent:ethylene carbonate(EC):propyl propionate(PP):ethyl propionate(EP):diethyl carbonate(DEC):ethyl methyl carbonate(EMC)=2:1:1:1:1:1; LiFP6 lithium salt concentration is 1.4 mol/l; electrolyte additive: 0.5% wt lithium difluoro(oxalato)borate (LiODFB), 0.5% wt lithium bis(oxalate) borate (LiBOB), 1.0% wt lithium bis(trifluoromethanesulphonyl)imide (LiTFSI), 2.0% wt adiponitrile (AND), 1.0% wt succinonitrile (SN), 4% wt propylene sulfite (PS), 0.5% vinylene carbonate (VC), 1.0% ethylene sulfite (DTD), 0.5% 1,3-propylene sultone (PST).

Test result is shown as below:
1. Discharge situation for different high voltage and high rate, and Table 1 is performance parameters of lithium-ion battery at different discharge rates, FIG. 1 is rate discharge curve of lithium-ion battery and performance parameters of lithium-ion battery at different work voltage.

TABLE 1

| | Discharge rate | | | | | | |
|---|---|---|---|---|---|---|---|
| | 1C | 3C | 5C | 8C | 10C | 12C | 15C |
| Discharge | 8395 | 8325 | 8304 | 8264 | 8201 | 8120 | 7769 |
| capacity | | | | | | | |
| (mAh) | | | | | | | |
| Discharge | 32519 | 31445 | 30778 | 29950 | 29355 | 28722 | 27029 |
| energy | | | | | | | |
| (mWh) | | | | | | | |
| Weight | 264.7 | 255.9 | 250.5 | 243.8 | 238.9 | 233.8 | 220.0 |
| energy | | | | | | | |
| density | | | | | | | |
| (Wh/Kg) | | | | | | | |
| Discharge | 100% | 99.2% | 98.9% | 98.4% | 97.7% | 96.7% | 92.5% |
| capacity | | | | | | | |
| retention | | | | | | | |
| rate %/1C | | | | | | | |

2. Cycle life:

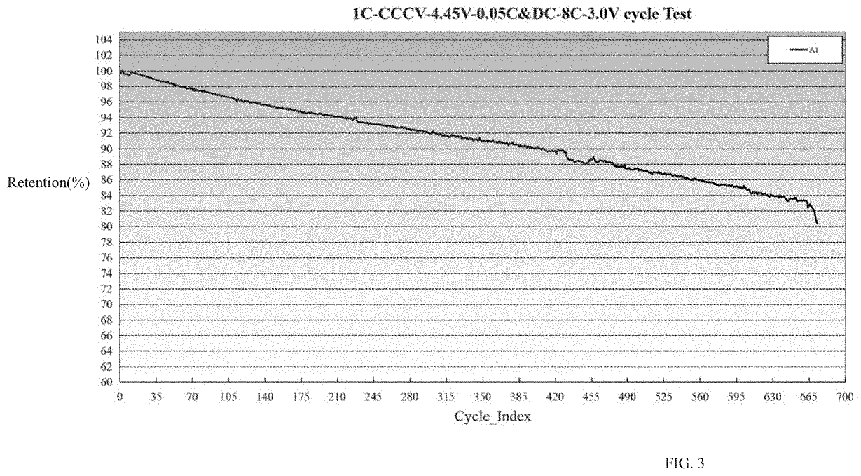

Charge to 4.45 V with IC(8 A) constant current, and then charge with 4.45 V constant voltage to cut off current 0.05 C, standby for 10 min, then use 8 C(64 A) current to discharge to 3.0 V cycle life is 670 weeks. As it's shown in FIG. 3, it's diagram of charge and discharge cycle life change of lithium-ion battery, abscissa is Cycle-Index and ordinate is Retention.

It's clear to find out in Table 1 that discharge rate of lithium-ion battery made with electrolyte adopted in this application can reach 15 C rate discharge, and discharge capacity retention rate can reach 92.5%/1 C at 15 C discharge, weight energy density is 220.0 Wh/Kg, discharge energy is 27,029 mWh, discharge capacity is 7,769 mAh. In addition, when discharge rate is IC, discharge capacity retention rate can reach 100%/1 C, weight energy density is 264.7 Wh/Kg, discharge energy is 32,519 mWh and discharge capacity is 8,395 mAh. As it's shown in FIG. 3, charge to 4.45 V with 1 C(8 A) constant current, and then charge with 4.45 V constant voltage to cut off current 0.05 C, standby for 10 min, then use 8 C(64 A) constant current to discharge to 3.0 V, cycle life is 670 weeks. Therefore, the conclusion is that the applied high voltage and high rate electrolyte can reach high voltage, high rate and high capacity at the same and it can effectively improve high rate charge and discharge cycle performance, which means it can boost cycle life of lithium-ion battery with high voltage and high rate.

Each technical characteristics of all mentioned cases above can be casually combined. It has not described every technical characteristics for all possible combinations from cases above in order to make it brief. However, if there is no contrary between these technical combinations, then all shall be deemed as scope of this invention prescribes.

Cases listed above only express some implementation methods of this invention, their descriptions are specific and detailed, but it shall not be deemed as limits to patent scope of the invention. It is necessary to point out that ordinary technicians in the field can make some transformations and improvements without separating from this invention thinking, all these belong to protection scope of this invention. Therefore, the protection scope of this invention patent shall refer to requirements in the attached Claims.

1. An electrolyte, including following groups of quantity shares:

| | |
|---|---|
| lithium salt | 12-18 shares; |
| linear carbonic ester | 20-35 shares; |
| cyclic carbonic ester | 20-35 shares; |
| carboxylic ester | 20-50 shares; and |
| functional additive | 10-15 shares. |

2. The electrolyte as described in claim 1, wherein lithium salt is one of following items including lithium bis(trifluoromethanesulphonyl)imide, lithium di(fluorosulfonyl)imide and lithium hexafluorophosphate.

3. The electrolyte as described in claim 1, wherein linear carbonic ester is at least one of following items including diethyl carbonate, ethyl methyl carbonate and dimethyl carbonate.

4. The electrolyte as described in claim 1, wherein cyclic carbonic ester is at least one of following items including ethylene carbonate, ethyl methyl carbonate and dimethyl carbonate.

5. The electrolyte as described in claim 1, wherein carboxylic ester is at least one of the following items including propyl propionate and ethyl propionate.

6. The electrolyte as described in claim 1, wherein the mentioned functional additive is at least one of following items including lithium salt additive, nitrile additive, sulfur additive, fluorine additive, vinylene carbonate and 1-propanephosphonic solution.

7. The electrolyte as described in claim 6, wherein the mentioned lithium salt additive is at least one of following items including lithium difluoro(oxalato)borate, lithium bis(oxalate) borate and lithium bis(trifluoromethanesulphonyl)imide.

8. The electrolyte as described in claim 6, wherein the mentioned nitrile additive is at least one of following items including adiponitrile, succinonitrile and 1,3,6-Hexanetricarbonitrile.

9. The electrolyte as described in claim 8, wherein the quantity of mentioned adiponitrile is 0.34-0.7 shares.

10. The electrolyte as described in claim 8, wherein the quantity of mentioned succinonitrile is 2-4 shares.

11. The electrolyte as described in claim 8, wherein the purity of mentioned succinonitrile is over 99.95%.

12. The electrolyte as described in claim 6, wherein the mentioned sulfur additive is at least one of following items including propylene sulfite, ethylene sulfite and 1,3-propylene sultone.

13. The electrolyte as described in claim 6, wherein fluorine additive is at least one of following items including fluoroethylene carbonate and lithium difluorophosphate.

14. The electrolyte as described in claim 13, wherein the quantity of mentioned fluoroethylene carbonate is 1-3 shares.

15. A preparation method of an electrolyte, wherein the preparation method includes following steps:
mixing linear carbonic ester, cyclic carbonic ester and carboxylic ester will obtain mixed organic solvent;
adding lithium salt to mixed organic solvent above and mix them for the first time, premixing electrolyte will be obtained; and
adding functional additive in accordance with weight ratio to the mentioned premixing electrolyte above and mix them for the second time, the mentioned electrolyte will be obtained.

16. The preparation method as described in claim 15, wherein mass ratio of mentioned linear carbonic ester, cyclic carbonic ester and carboxylic ester is 2:3:2.

17. The preparation method as described in claim 15, wherein mass ratio of mentioned linear carbonic ester and cyclic carbonic ester is 1/1˜4/7.

18. The preparation method as described in claim 15, wherein mass ratio of cyclic carbonic ester and carboxylic ester is 1/1˜2/5.

15. preparation method as described in claim 15, wherein the concentration of mentioned lithium salt is 1.0 mol/L˜1.8 mol/L.

20. The preparation method as described in claim 15, wherein the adding quantity of mentioned functional additive is 2% wt˜5% wt.

21. A lithium-ion battery including an electrolyte as described in claim 1.
